(19) United States
(12) Patent Application Publication
(10) Pub. No.: US 2008/0060879 A1
(43) Pub. Date: Mar. 13, 2008

(54) Reusable Fluid Dispenser

(75) Inventors: Anton Orlitzky, British Columbia (CA); Diana Lencar, British Columbia (CA); Danny Sheremeta, British Columbia (CA); Klaus Oehr, British Columbia (CA); Colin Oloman, British Columbia (CA)

Correspondence Address: GORDON & REES LLP, 101 WEST BROADWAY, SUITE 1600, SAN DIEGO, CA, 92101, US

(73) Assignee: A.T.S. Electro-Lube Holdings Ltd., Delta, British Columbia (CA)

(21) Appl. No.: 10/563,791

(22) PCT Filed: Jul. 7, 2004
(86) PCT No.: PCT/CA04/00994

§ 371 Date: Mar. 8, 2007

Related U.S. Application Data
(60) Provisional application No. 60/484,657, filed on Jul. 7, 2003.

(51) Int. Cl. F16N 11/10

(52) U.S. Cl. 184/39

(57) ABSTRACT

The invention provides, in general, a reusable gas driven fluid transportation apparatus having subsystems or components that are adapted to be reused, replaced and/or recycled. All or a portion of the subsystems or components of the apparatus may be reused by replacement of parts (such as the gas generating unit) or by replacement of consumed components such as gas generating reactants, batteries or fluid. The apparatus may be used, for example, for applying lubricant to machine components such as a bearing.

### FIELD OF THE INVENTION

The invention is in the field of fluid dispensation. More specifically, the invention is in the field of reusable fluid dispensing devices.

### BACKGROUND OF THE INVENTION

Devices to generate gases as means for transporting fluids in technical applications, for example, for the transport of lubricants such as grease to machine parts (e.g., bearings), may use spontaneous electrochemical reactions, non-spontaneous electrochemical reactions, or spontaneous thermo-chemical reactions for gas generation. Non-spontaneous electrochemical devices have typically relied on the application of current, by one or more external batteries, to the positive and negative terminals of an electrochemical cell to generate gas at a rate which is a function of the external electrical resistance of the circuit, the chemistry of the system, the size and configuration of the cell, and the temperature. The gas discharge rate of such cells is typically controlled by changing the external resistance in series with the gas generating electrochemical cell under a fixed potential (voltage) from the single or multiple batteries.

However it is produced, the discharged gas may be vented under pressure towards a separator such as a piston or a bellows adjacent to, for example inside, a piston on the opposite side of a fluid such as a bearing lubricant. The lubricating fluid is located in a chamber in which the separator, under pressure of the vented gas, slowly moves towards a chamber orifice and in so doing forces lubricant out of the orifice; Such generators produce a variety of gases, especially nitrogen and hydrogen and occasionally oxygen or carbon dioxide to apply pressure to the separator.

Representative patents in this field include the following: US Pat. No. 5,404,966; U.S. Pat. No. 5,242,565; U.S. Pat. No. 5,968,325; U.S. Pat. No. 4,023,648; U.S. Pat. No. 4,671,386; U.S. Pat. No. 5,460,242; U.S. Pat. No. 5,427,870; U.S. Pat. No. 5,547,043; EP 0 581 795; U.S. Pat. No. 4,640,445.

### SUMMARY OF THE INVENTION

In one aspect, the invention provides a fluid dispenser adapted so that various components are reusable. The dispenser may for example comprise releasably connected subsystems, such as a subsystem A and a subsystem B.

Subsystem B may for example have a fluid reservoir adapted for containing a fluid, such as a lubricant. The fluid reservoir may include a fluid outlet adapted for dispensing fluid contained in the fluid reservoir. The fluid reservoir may also include a separator movably positioned in a dispensing position to bias fluid contained in the fluid reservoir out of the fluid outlet, to dispense the fluid through the fluid outlet. The separator may for example be capable of preventing gas from moving into the reservoir. The fluid reservoir may further include a fluid inlet positioned for recharging the fluid reservoir with a replaceable fluid while biasing the separator into the dispensing position.

Subsystem A may for example have a power head assembly removably attached to the fluid reservoir, comprising a gas generator in fluid communication with the separator. The removable attachment of subsystem A may be adapted to facilitate periodic replacement of the subsystem. Gas generated by the gas generator may be communicable to the separator to move the separator to dispense the fluid.

The connection of the components of the subsystems, such as the power head assembly, may be adapted so that various components of the lubricant dispenser are replaceable. Similarly, the subsystems may be attached to facilitate their replacement.

### BRIEF DESCRIPTION OF THE DRAWINGS

FIG. 1 is a diagram of a spontaneous electrochemical gas generating system.

FIG. 2 is a diagram of a non-spontaneous (battery-driven) electrochemical gas generating system, in which:
33 is an anode (perforated, diameter=36 mm.)
34 is a cathode (diameter=36 mm.)
30 is a PVC unit
32 is a bellows
35 is a sponge (soaked with electrolyte)
31 is a 3 Volt lithium battery
36 is an external resistor

FIG. 3 is a diagram of a spontaneous thermochemical gas generating system.

FIGS. 4A and B show the operation of subsystem B with bellows alone. FIG. 4A is a diagram of subsystem B with bellows alone. FIG. 4B is a plot of grease discharge vs time with bellows alone.

FIG. 5 is a diagram of subsystem B with bladder alone.

FIGS. 6A, B and C show the operation of subsystem B with piston alone. FIG. 6A is a diagram of subsystem B with piston alone. FIG. 6B is a plot of gas produced vs time with piston alone. FIG. 6C is a plot of grease discharge vs time with piston alone.

FIGS. 7A and B show the operation of subsystem B with bellows and piston. FIG. 7A is a diagram of subsystem B with bellows and piston. FIG. 7B is a plot of grease discharge vs time with bellows and piston.

FIG. 8 is a diagram of subsystem B with bladder and piston.

FIG. 9A through 9H are diagrams of a fluid transportation apparatus (“Econo-Luber”). An assembled view of the Econo-Luber is shown with bellows (FIG. 9A), with bellows fully extended (FIG. 9D), and with bellows fully retracted (FIG. 9E). An assembled view of subsystem A (FIG. 9B) and subsystem B (FIG. 9C) of the Econo-Luber is also shown. Exploded views of the Econo-Luber (FIG. 9F), of subsystem A (FIG. 9G), and of subsystem B (FIG. 9H ), all with bellows are also shown.

FIG. 9I is a graph showing grease discharged over time by a prototype lubricator with piston and bellows.

FIGS. 10A through 10C show embodiments of the electrical circuit used to control the current, and hence the gas generation rate, in the electrochemical cell. FIG. 10A is a conceptual diagram of a basic control circuit with multiple resistors and switches. FIG. 10B is a conceptual diagram of a more advanced control circuit in which the current is modulated by variation in the pressure and/or temperature in the lubricator. FIG. 10C shows the circuit of FIG. 10A with details of the type needed for its commercial production.

### DETAILED DESCRIPTION OF THE INVENTION

The invention provides, in one aspect, a reusable gas driven fluid dispensing apparatus having subsystems or components that may be adapted to be reused, replaced and/or recycled. All or a portion of the subsystems or components of the apparatus may be reused by replacement of consumed sub-components such as gas generating reactants, single or multiple batteries or fluids. The apparatus may be used, for example, for applying lubricant to machine components such as a bearing.

In some embodiments, the apparatus includes two subsystems, designated A and B, where subsystem A is a gas generating cell capable of venting gas to subsystem B, and subsystem B is a fluid dispenser capable of discharging a fluid through an outlet, and capable of being refilled through an inlet, for example, a one-way grease fitting known as a “zirk” fitting. The fluid is discharged by the force of a separator moving the fluid toward the outlet of subsystem B, a dispensing force is generated by the pressure of the gas vented from subsystem A into subsystem B to move the separator and thereby dispense the fluid.

In one aspect, the invention provides a reusable fluid dispenser comprising connected subsystems, such as a subsystem A and a subsystem B. Subsystem B may for example have a fluid reservoir adapted for containing a fluid, such as a lubricant (for example a bearing grease or an oil). The fluid reservoir may include a fluid outlet adapted for dispensing fluid contained in the fluid reservoir. The fluid reservoir may also include a separator movably positioned in a dispensing position to bias fluid contained in the fluid reservoir out of the fluid outlet, to dispense the fluid through the fluid outlet. The separator may for example be capable of preventing gas from moving into the reservoir, and may for example include a bellows, a bladder and/or a piston. A flexible bellows may for example be hermetically sealed to a bellows mounting base using ultrasonic welding, while subsystem A is coupled to subsystem B by o-rings. The fluid reservoir may further include a fluid inlet positioned for recharging the fluid reservoir with a replaceable fluid while biasing the separator into the dispensing position. The fluid inlet may, for example, be a one-way grease fitting, such as a zirk fitting.

Subsystem A may for example have a power head assembly removably attached to the fluid reservoir, comprising a gas generator in fluid communication with the separator. The removable attachment of subsystem A may be adapted to facilitate periodic replacement of the subsystem. Gas generated by the gas generator may be communicable to the separator to move the separator to dispense the fluid. The gas generator may for example be capable of generating gas by a gas generating reaction such as spontaneous or non-spontaneous reactions, including electrochemical reactions or thermochemical reactions. In some embodiments, the rate of the gas generating reaction may be adjustable. The generated gas may for example be nitrogen, hydrogen, carbon dioxide, nitrous oxide, oxygen. The gas may for example be generated via the decomposition of one or more azide or azole containing reactants.

The connection of the components of the subsystems, such as the power head assembly, may be adapted so that various components of the lubricant dispenser are replaceable, such as: i) a power head comprising a switchboard, a battery, an electrochemical cell and a switchcap; ii) a cylinder or a lubricant reservoir; iii) a bellows comprising a mounting base; iv) a piston; v) a locking ring; or, vi) a fluid. Similarly, the subsystems may be removably attached to facilitate their replacement. For example, the subsystem A gas generating unit may be threaded into the subsystem B lubricant dispenser, to removably attach the subsystems while creating a hydraulic seal during the venting of gas from subsystem A to subsystem B. In an alternative embodiment o-rings may be interposed between the subsystem A gas generating unit and the subsystem B fluid dispenser wherein subsystem A is held to subsystem B by the locking ring. The method of coupling subsystem A to subsystem B is arranged to prevent the escape of gas from the union, for example by the disposition of o-rings on the bellows mounting base and/or the power head. The dispenser itself may be removably attached to a mechanical device, such as a bearing, to which the lubricant is applied by the dispenser.

In alternative embodiments, the apparatus may for example be capable of generating a range of gases by spontaneous or non-spontaneous electrochemical reactions, or by spontaneous thermochemical reactions. In alternative embodiments, the gas generation may be automatic or spontaneous. In alternative embodiments, the gas is generated at an adjustable rate.

In some embodiments, the apparatus may for example include a subsystem A that contains: 1) a single or multiple batteries activated by one or more switches 2) a positive and negative electrode separated by an absorbed or gelled electrolyte and connecting screws, coated with a thread sealer (e.g. Locktite) or other sealing means (eg. epoxy glue), allowing the positive and negative electrodes to make electrical contact to the positive and negative electrodes respectively of the single or multiple battery assembly, seals preventing leakage of electrolyte into the battery or switch assembly or leakage of electrolyte from subsystem A into subsystem B.

In some embodiments, for example, subsystem A may contain either or both of a nuts and/or springs to ensure more reliable contact between the electrode screws and the battery assembly.

In alternative embodiments, the apparatus may for example include a subsystem A that contains: 1) a spontaneous electrochemical cell activated by one or more switches 2) a positive and negative electrode separated by an absorbed or gelled electrolyte and connecting screws, coated with a thread sealer (e.g. Locktite) or other sealing means (eg. epoxy glue), allowing the positive and negative electrodes to make electrical contact to the positive and negative electrodes respectively of the single or multiple battery assembly, seals preventing leakage of electrolyte into the battery or switch assembly or leakage of electrolyte from subsystem A into subsystem B.

In some embodiments, subsystem A may contain: 1) spontaneous thermo-chemical reactants activated on contact; and 2) seals preventing leakage of reactants from subsystem A into subsystem B. Subsystem A may also include a threadable cap which can be unscrewed from the subsystem A assembly, which may be adapted so as to facilitate replacement of either or both of the switching or battery assembly, to allow access to the power switches for setting up the unit lubricant discharge rate, to separate the circuit board from the environment, or to allow observation of unit switch settings and other components for example a flashing LED.

### EXAMPLES

In an alternative embodiment, the invention is described both in terms of each subsystem A and B separately, and as a complete integrated unit capable of dispensing fluids (for example, a lubricant) at controlled rates over extended periods (for example, up to 2 years).

### Subsystem A

A range of options for use as the gas generating device in the “power head” of subsystem A for fluid (for example, lubricant) dispensing applications are shown in Table 1. These options may be desirable to meet, for example, various market demands for cost, place of use, ambient temperature conditions, etc. Details of the gas generation systems typified by options 1,5,7, 8, and 10 in Table 1 may be found, for example, in U.S. Pat. Nos. 5,968,325, 6,299,743, and 6,299,743; U.S. patent application Ser. No. 10/061,754, and in EP 0 581 795, all incorporated herein by reference.

TABLE 1
Embodiments of Gas Generator Options for Subsystem A.

| | | | | | | | Spontaneous thermochemical | | |
|---|---|---|---|---|---|---|---|---|---|
| | | | | Non-spontaneous electrochemical | | | [Reactants in solid, contacted with | | |
| | Spontaneous electrochemical | | | [Driven by external battery, with external | | | liquid] | | |
| | [Controlled by external resistor] | | | resistor] | | | | | Solid |
| Option | Gas | Anode-cathode | Electrolyte | Gas | Anode-cathode | Electrolyte | Gas | Reactants | matrix |
| 1 | H₂ | Zn—Pt/Ni | KOH, H₂O | | | | | | |
| 2 | H₂ | Zn—Pt/C | H₂SO₄, H₂O | | | | | | |
| 3 | N₂ | C—MnO₂/C | Tetrazole | | | | | | |
| | | | Ion | | | | | | |
| | | | membrane | | | | | | |
| | | | H₂SO₄, H₂O | | | | | | |
| 4 | N₂ | C—MnO₂/C | NaN₃, KI | | | | | | |
| | | | Ion | | | | | | |
| | | | membrane | | | | | | |
| | | | KOH, H₂O | | | | | | |
| 5 | N₂ | C—MnO₂/C | Methylhydrazino | | | | | | |
| | | | carboxylate | | | | | | |
| | | | Ion | | | | | | |
| | | | membrane | | | | | | |
| | | | H₂SO₄, H₂O | | | | | | |
| 6 | | | | N₂ | C³/polymer-C/polymer | NaN₃, KI | | | |
| | | | | | | KSCN, H₂O | | | |
| | | | | | | DMSO¹ | | | |
| 7 | | | | N₂ | C/polymer-C/polymer | K Tetrazole | | | |
| | | | | | C felt-C cloth | Isonicotinic | | | |
| | | | | | | acid | | | |
| | | | | | | H₂O, DMSO | | | |
| 8 | | | | N₂ | C/Nylon-C/Nylon | Methylhydrazino | | | |
| | | | | | | Carboxylate | | | |
| | | | | | | Nitroguanidine | | | |
| | | | | | | NaCl, H₂O | | | |
| 9 | | | | CO₂ | DSA⁴(RuO₂)/Ti—SS² | Cu(HCOO)₂ | | | |
| | | | | | | H₂O | | | |
| 10 | | | | | | | N₂ | CH₃NHCl | Paraffin |
| | | | | | | | | NaNO₂ | Wax |
| | | | | | | | | H₂O | |
| | | | | | | | | Et³ glycol | |
| 11 | | | | | | | N₂ | K tetrazole | Epoxy |
| | | | | | | | | KNO₂, H₂O | polymer |
| | | | | | | | | | Polyvinyl- |
| | | | | | | | | | acetate |
| 12 | | | | | | | N₂/N₂O | NaN₃ | Epoxy |
| | | | | | | | | KNO₂, H₂O | polymer |
| | | | | | | | | DMSO | |
| 13 | | | | | | | CO₂ | NaHCO₃ | Epoxy |
| | | | | | | | | CH₃COOH | polymer |
| | | | | | | | | H₂O | |

¹DMSO—dimethyl sulfoxide
²SS—stainless steel
³Et—ethylene
⁴DSA—dimensionally stable anode
⁵C—carbon. Polymer = Nylon

Further examples of three types of gas generator are described below.

### Spontaneous Electrochemical System

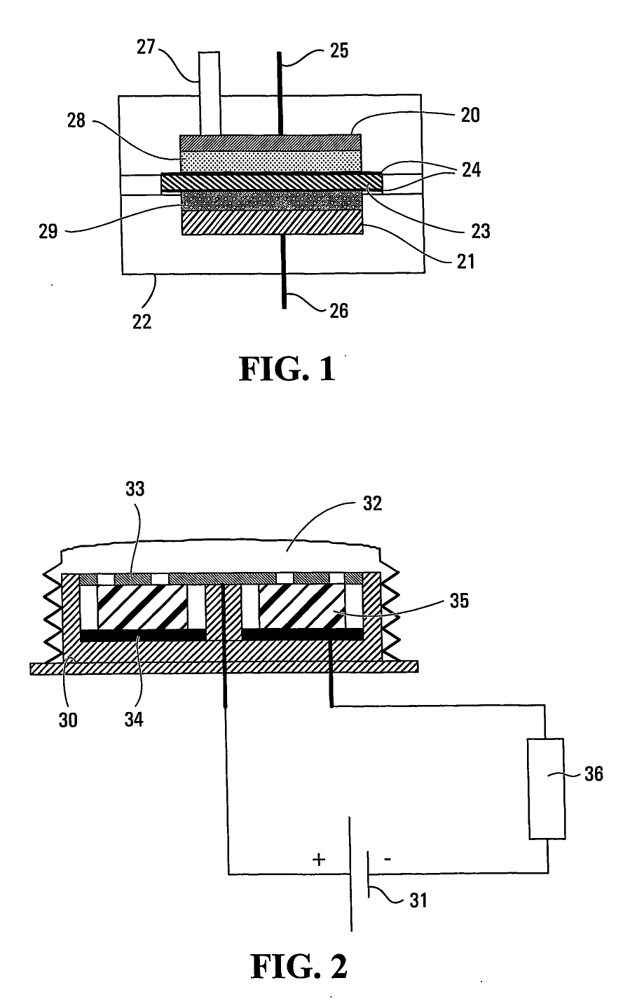

The electrochemical cell of FIG. 1 consists of a graphite/Nylon anode 20 and a graphite cathode 21 , each 50 mm diameter disks set at the bottom of 10 mm deep chambers milled into PVC bar stock 22. The chambers are loaded respectively with anode and cathode reactants based on option 3 of Table 1. The electrolyte chambers are separated by a 10 mm thick gel of 2M NaOH 23 held between two sheets of Nafion 350 cation exchange membrane 24 (obtained from DuPont de Nemours). This cell registered 1.08 V on open circuit as measured between the anode contact 25 and the cathode contact 26, and when connected through a 0.71 kOhm resistor operated for 30 days with average current of 0.4 mA and nitrogen gas generation rate of 10 ml (at standard temperature and pressure—“STP”) per day at gas outlet 27. In one aspect, the electrolytic cell may comprise an anolyte 28 and a catholyte 29, such as K Tetrazole anolyte and a MnO₂/C/H₂SO₄ catholyte.

### Non-Spontaneous (Battery Driven) Electrochemical System

The electrochemical gas generator shown in FIG. 2 consists of an electrochemical cell in a 36 mm diameter by 11.5 mm deep recess milled into PVC bar stock 30, on one side connected to a battery 31 and on the other side connected either to a gas burette or contained in a plastic bellow 32 as part of a prototype lubricant dispenser. In the electrochemical cell the electrode materials 33 and 34 (used in various combinations) are: Nylon impregnated graphite, graphite sheet (Grafoil obtainable from Union Carbide Corp.), graphite cloth and graphite or carbon felt (which may be obtainable-respectively from The Electrosynthesis Company, Metaullics Systems Inc. and SGL Carbon Inc.). The electrolyte, consisting a mixture based on option 7 of Table 1, is absorbed into a cellulose sponge 35 and/or the graphite cloth/felt. This cell is driven by an external 3 V battery connected through a bank of resistors 36 that served to set the current, and hence the rate of gas generation. Typical operation of this unit for periods up to 70 days at 22 ° C. with external resistance of 2.76 kOhm shows an average current of 0.48 mA, generating about 5 ml STP gas per day with 90+volume % nitrogen. Further examples of non-spontaneous electrochemical gas generators may be found in U.S. patent application Ser. No. 10/061,754, herein incorporated by reference. Such systems can be elaborated by, for example, variations in electrode material, use of three-dimensional electrodes (e.g. cloth, felt, screen, powder or gas diffusion), variation in the electrolyte composition, choice of separator/absorbent material (e.g. sponge, gel, felt or powder), and the optional use of micro-porous hydrophobic materials (e.g. PTFE, polypropylene) to prevent electrolyte leakage from the cell.

### Spontaneous Thermo-Chemical System

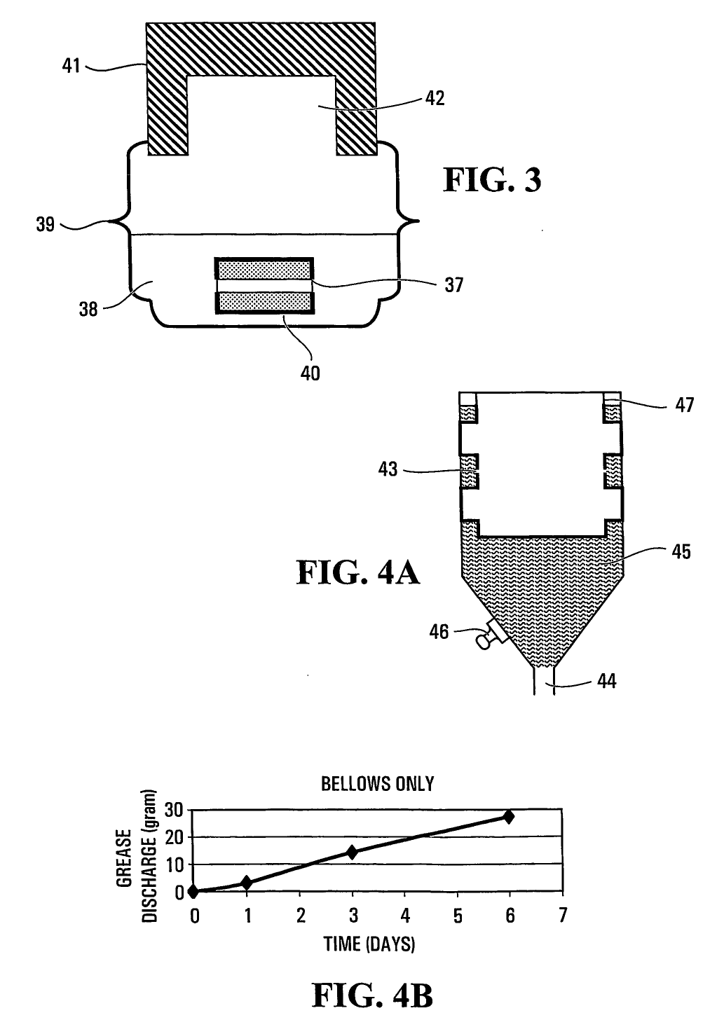

A wide variety of thermo-chemical gas generators may be used in alternative gas generators of the invention. Such systems may for example include a reactive solid pellet 37 and a reactant liquid 38 separated by a membrane that is broken to allow contact between the solid and the liquid to activate the unit. The thermo-chemical gas generator shown in FIG. 3 consists of a 12 mm diameter by 16 mm long reactive pellet immersed in 45 ml of liquid contained in the plastic bellows 39 of a prototype lubricant dispenser. The pellet contains a solid mixture based on option 11 of Table 1, with an impervious polymeric coating 40 and three 1.7 mm diameter holes drilled through its length to expose the reactants. The liquid contains acetic acid, DMSO and quaternary ammonium salt (Buckleye QUAT 256, obtainable from AISCO Industrial Supply, Richmond, British Columbia, Canada) in water. Over a 60 day operating period at 22° C. this device produces 100 ml STP of gas containing about 90 volume % nitrogen. In this case the rate of gas generation is controlled by the area of active surface exposed to the liquid reactant (e.g. by the number and size of holes drilled through the pellet) and/or optionally by directional variations in the composition of pellet. In one aspect, the electrolytic cell may comprise a solid head 41 to which the bellows are attached. This solid head may include a pellet receptacle 42 for holding the reactive pellet prior to activation of the cell. This thermo-chemical principle can be used to generate a range of gases including, for example, hydrogen by reaction of a metal, such as aluminum, with acid or base; oxygen by reaction of a peroxy compound with iodide or permanganate; carbon dioxide by reaction of a carbonate with an acid.

### Subsystem B

A number of options are available (to function as the separator) and transfer the gas pressure to fluid motion in subsystem B (Table 2), and are illustrated in principle herein.

TABLE 2
Summary of Embodiments for Motivating Fluid in Subsystem B

| Option | Motive device |
|---|---|
| 1 | Bellows |
| 2 | Elastic bladder |
| 3 | Piston |
| 4 | Piston + bellows |
| 5 | Piston + bladder |

### Bellows

As shown in FIG. 4A, a bellows 43 alone can drive a desired fluid 45 (for example, a lubricant) from the dispensing subsystem B fluid outlet 44. The bellows alone embodiment has the advantage that it is relatively inexpensive. In some embodiments, bellows alone may allow the lubricant to flow behind the corrugations, and may reduce the efficiency of lubricant discharge from the system. In one aspect, the subsystem may include a one-way fluid inlet such as a zirk fitting 46.

An experimental lubricator unit was prepared with the following specifications:

| | | |
|---|---|---|
| Anode/cathode. | Nylon impregnated carbon fibre | Diameter = 50 mm |
| Electrolyte. | Potassium tetrazole + | |
| | isonicotinic acid + DMSO + | |
| | water in cellulose sponge | |
| | (option 7. Table 1) | |
| External battery. | 3 Volt | |
| External resistor. | 2.78 kOhm | |
| Motive device. | Polypropylene bellows alone | |

The lubricator was loaded with grease and discharged against atmospheric pressure, with results as shown in FIG. 4B.

### Bladder

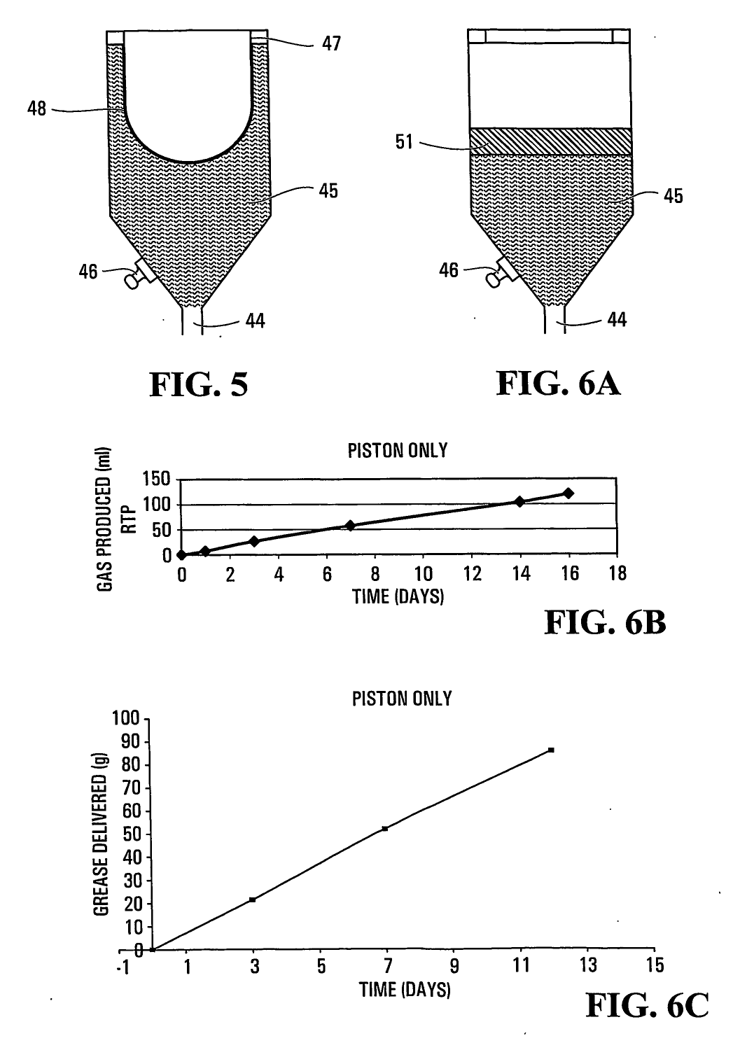

An elastic bladder 48 alone can drive lubricant 45 (or other desired fluid) from the dispensing subsystem B fluid outlet 44 (FIG. 5). The bladder alone embodiment has the advantage that it is relatively inexpensive. In some embodiments, a bladder alone may reduce the efficiency of lubricant discharge from the system. In some embodiments, a bladder may require extra gas pressure for its extension, and may be more subject to gas leakage by diffusion through the bladder material.

A commercial lubricator unit was prepared with the following specifications:

| | | |
|---|---|---|
| Anode/cathode. | Nylon impregnated carbon fibre. | Diameter = 50 mm |
| Electrolyte. | Sodium azide + | |
| | potassium iodide + | |
| | potassium thiocyanate + | |
| | DMSO + water in a cellulose | |
| | sponge (option 6. Table 1) | |
| External battery. | 2, 1.5 Volt in series | |
| External resistor. | 6 kOhm | |
| Motive device. | Rubber (neoprene) bladder alone | |

The lubricator was loaded with grease and discharged against atmospheric pressure. Over a 30 day period the rate of grease discharge ranged from an initial value of about 5 grams/day down to about 3 grams/day.

In both bladder and bellows systems, a gas tight connection 47 with the body of the unit, to prevent gas leakage into the lubricant and/or into the surrounding atmosphere, is useful.

### Piston

In some embodiments, discharge efficiency is improved by using a full fitting piston 51 to drive lubricant 45 from the unit fluid outlet 44, as shown in FIG. 6A. Construction of the system of FIG. 6A may require close tolerances to prevent gas leakage around the piston. This problem may for example be resolved using O-rings around the circumference of the piston. In alternative embodiments, O-rings are not required.

An experimental lubricator unit was prepared with the following specifications:

| | | |
|---|---|---|
| Anode/cathode. | Nylon impregnated carbon fibre. | Diameter = 50 mm |
| Electrolyte. | Potassium tetrazole + | |
| | isonicotinic acid + DMSO + | |
| | water in cellulose sponge | |
| | (option 7. Table 1) | |
| External battery. | 3 Volt | |
| External resistor. | 2.78 kOhm | |
| Motive device. | Piston alone | |

The rate of gas generation, as measured by the piston movement, is shown in FIG. 6B

A similar lubricator was loaded with grease and discharged against atmospheric pressure, with results in FIG. 6C.

### Piston And Bellows

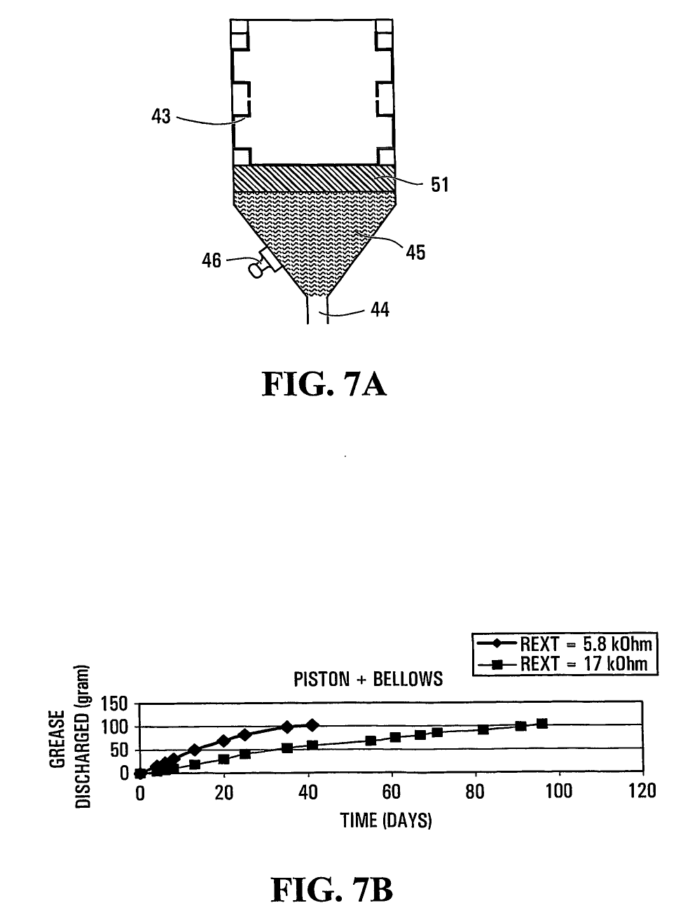

In some embodiments, the dual issues of discharge efficiency and leakage associated with the bellows and with the piston separately may be resolved when a bellows 43 and piston 51 are combined as, for example, shown in FIG. 7A.

A commercial lubricator unit was prepared with the following specifications:

| | | |
|---|---|---|
| Anode/cathode. | Nylon impregnated carbon fibre. | Diameter = 50 mm |
| Electrolyte. | Potassium tetrazole + | |
| | isonicotinic acid + | |
| | DMSO + water in cellulose | |
| | sponge (option 7. Table 1). | |
| External battery. | 3 Volt | |
| External resistor. | 5.8 kOhm and 17 kOhm. | |
| | (2 separate settings) | |
| Motive device. | Piston + bellows | |

### The lubricator was loaded with grease and discharged against atmospheric pressure, with results in FIG. 7B.

### Piston And Bladder

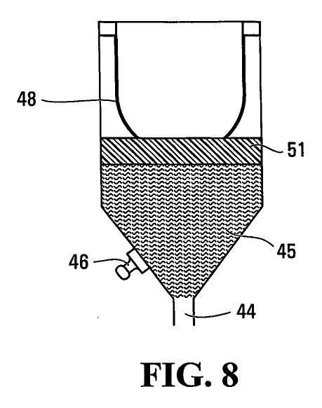

In some embodiments, a piston 51 and bladder 48 system as, for example, shown in FIG. 8 may be used. Excess pressure may be needed to expand the bladder and its material of construction must be carefully chosen to avoid gas leakage by diffusion.

### Integrated Fluid Transportation Apparatus

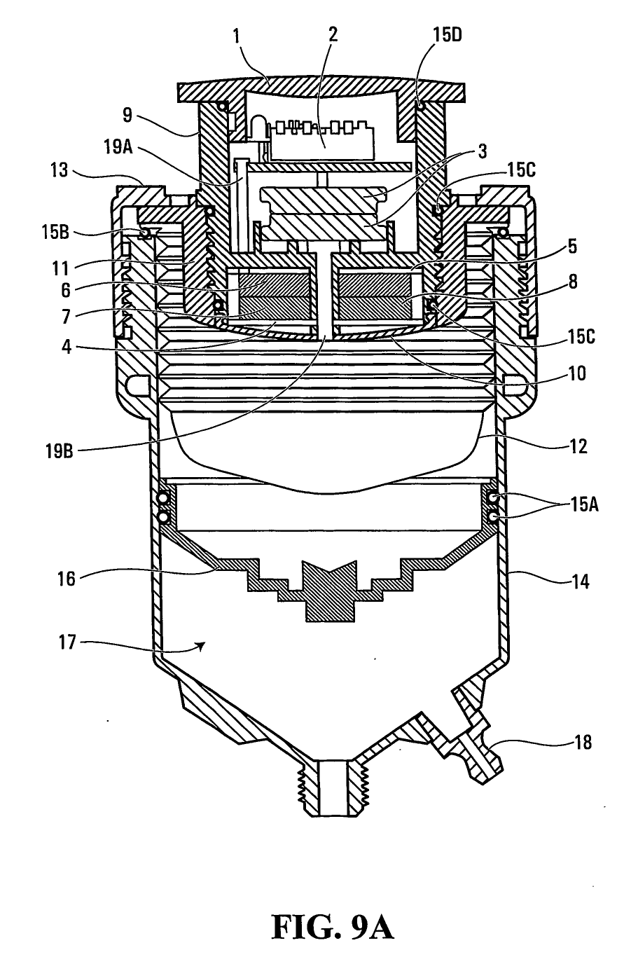

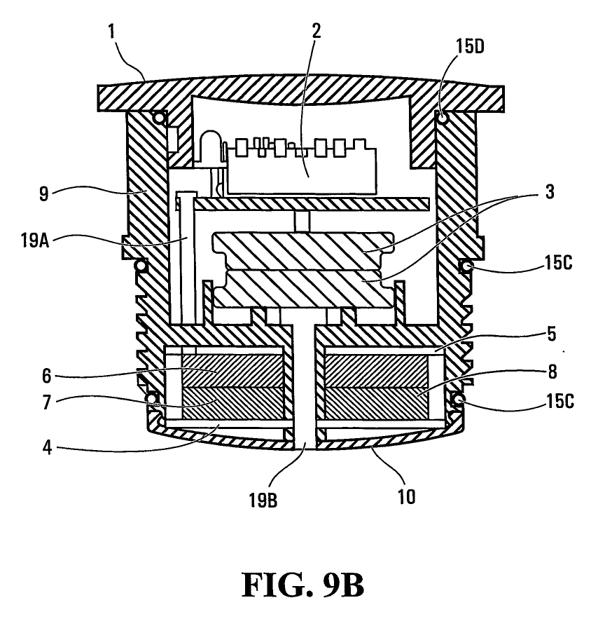

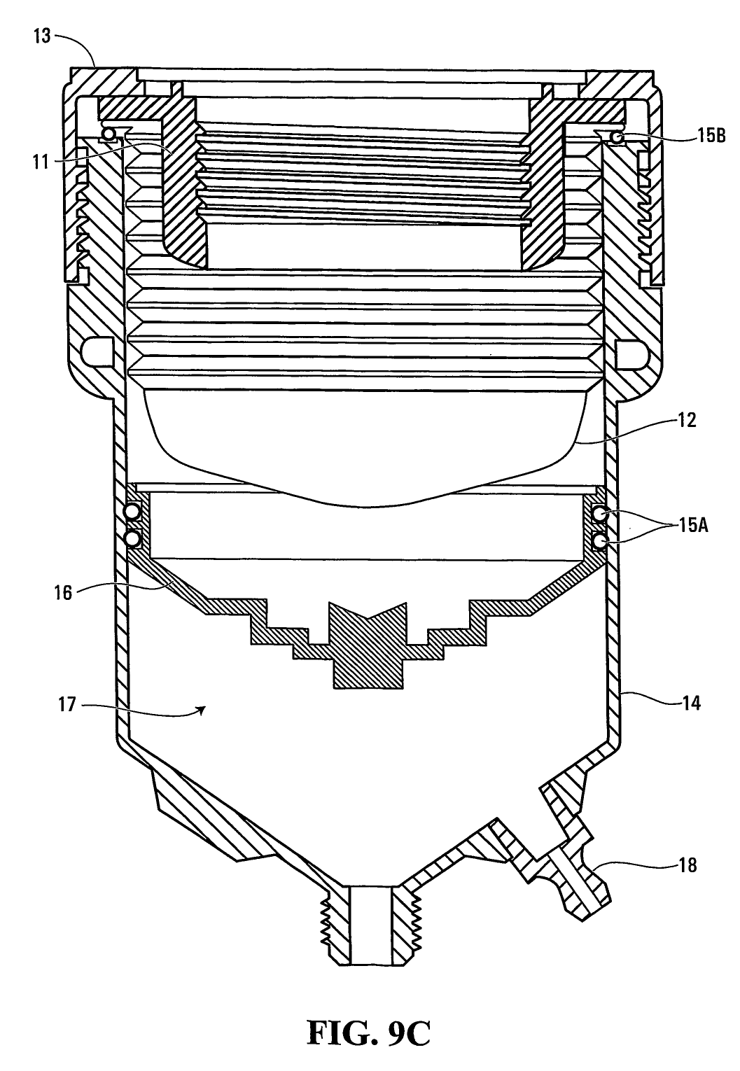

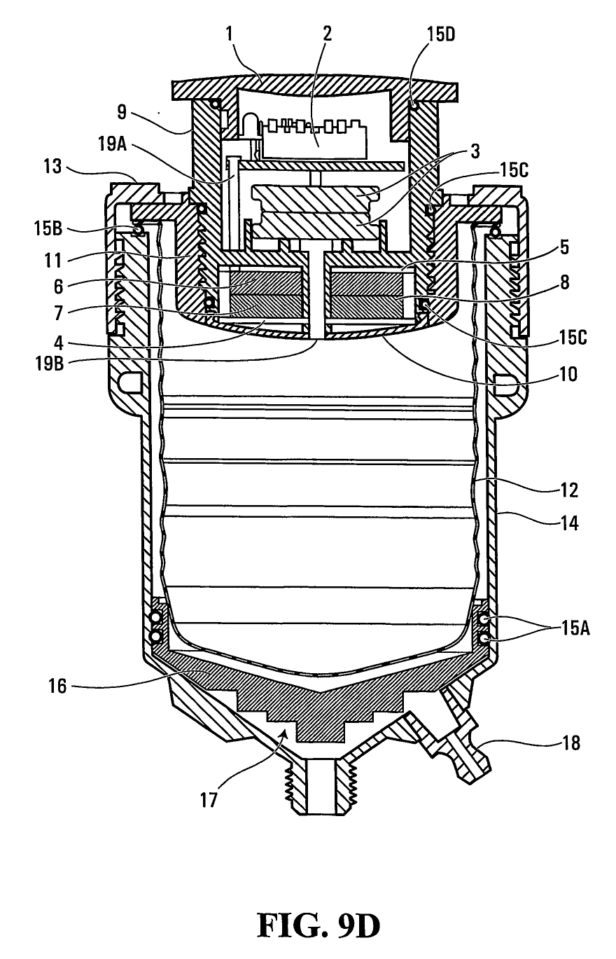

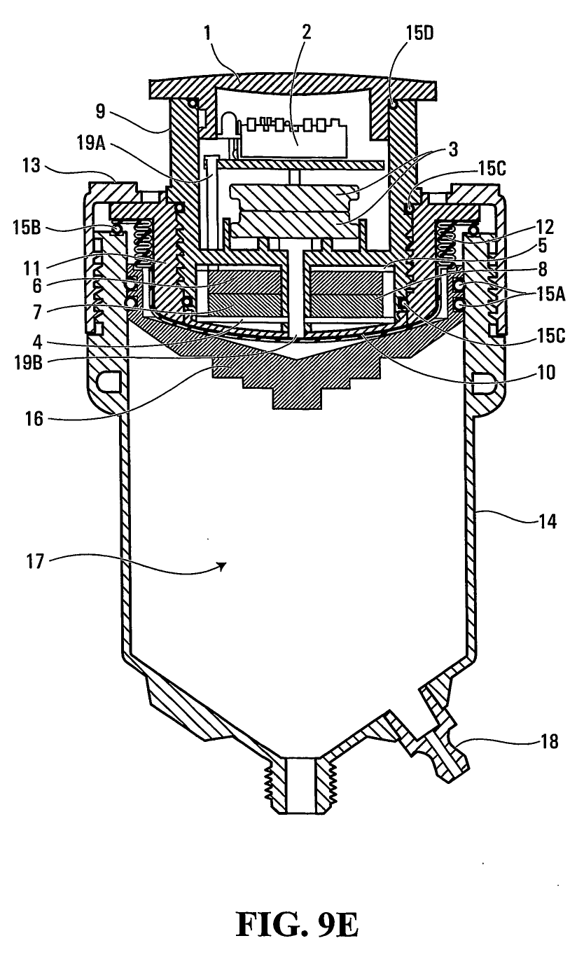

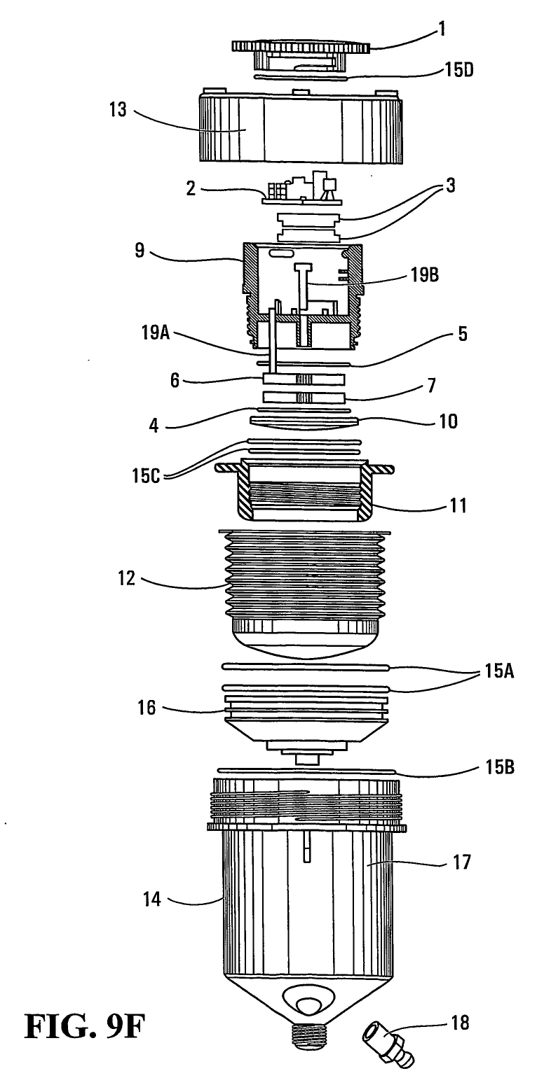

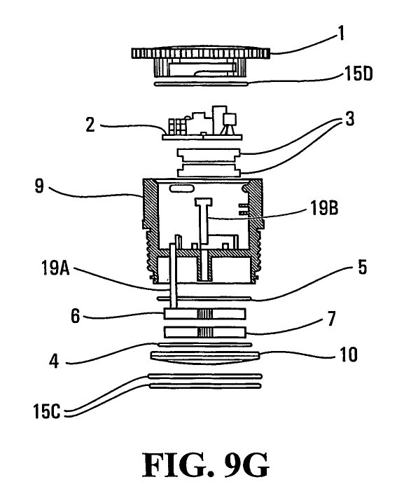

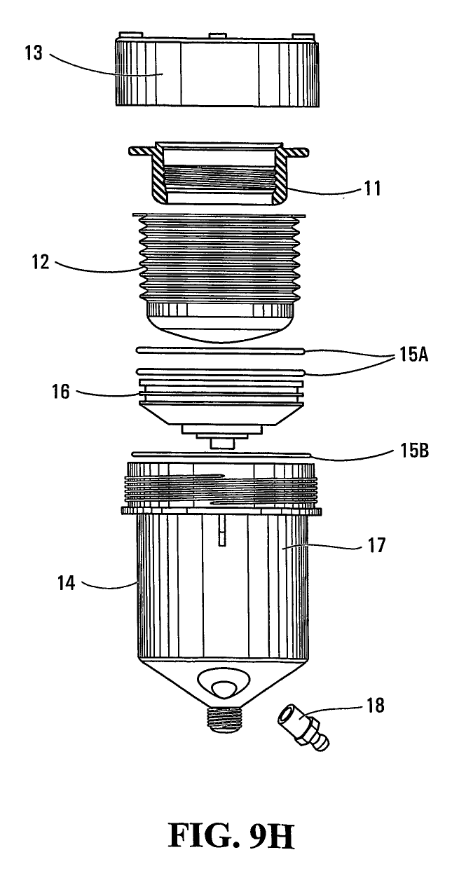

FIGS. 9A-H show a set of detailed assembly drawings of an embodiment of a complete fluid transportation apparatus, integrating:

| | | |
|---|---|---|
| Subsystem A. | Option 7 | Non-spontaneous electrochemical |
| | | generation of nitrogen from tetrazole |
| Subsystem B. | Option 4 | Piston + bellows |

A list of components of the integrated apparatus of FIGS. 9A-H, showing some of the embodiments of the components discussed herein, is shown in Table 3. The numerical code of Table 3 is carried through FIGS. 9A-H.

TABLE 3

| Item # | Description |
|---|---|
| 1 | Switch-cap |
| 2 | Circuit Board Assembly |
| 3 | Coin Cell Battery (2 total) |
| 4 | Positive Electrode (anode) |
| 5 | Negative Electrode (cathode) |
| 6 | Cellulose Sponge |
| 7 | Graphite Felt (optional) |
| 8 | Electrolyte (held in the sponge & felt) |
| 9 | Power Head |
| 10 | Chemical Cap |
| 11 | Bellows Mounting Base |
| 12 | Bellows |
| 13 | Lock Ring |
| 14 | Cylinder |
| 15 | O-ring (6 total those on the piston are optional) |
| 16 | Piston |
| 17 | Lubricant Reservoir |
| 18 | Grease Fitting (zirk) |
| 19 | Connecting Screw (2 total) |

A prototype fluid transportation apparatus was assembled according to FIGS. 9A-H and Table 3, with the following additional specifications:

| | | |
|---|---|---|
| Anode | Nylon impregnated graphite disk. | Diameter = 30 mm |
| Cathode. | Nylon impregnated graphite disk | Diameter = 30 mm |
| Electrolyte. | Potassium tetrazole + | |
| | isonicotinic acid + DMSO + | |
| | water in cellulose sponge | |
| | (option 7. Table 1). | |
| External | 3 Volt (2 batteries | |
| battery. | connected in parallel) | |
| External | 5.8 kOhm | |
| resistor. | | |
| Motive device. | Piston + bellows | |

Referring to FIGS. 9A-H, subsystem A may be assembled as follows. The negative electrode 5 is installed into the power head 9 using connecting screw 19A. The cellulose sponge 6 is installed into the power head 9, and the required amount of electrolyte 8 is added to the cellulose sponge 6. The positive electrode 4 is installed into the power head 9 using connecting screw 19B, the chemical cap 10 is installed onto the power head 9, and two coin cell batteries 3 are installed into the power head 9. The circuit board 2 is installed into the power head 9 using connecting screw 19A. O-ring 15D is assembled onto the switch cap 1, and the switch cap, complete with O-rings, is installed onto the power head 9. Two O-rings 15C are assembled onto the power head 9.

Referring to FIGS. 9A-H, subsystem B may be assembled with bellows as follows. A ⅛″ NPT hole is drilled and tapped into the cylinder 14 for the zirk fitting 18, and the zirk fitting is screwed in. The piston 16, is inserted into the cylinder 14. One O-ring 15B is installed onto the cylinder 14. The bellows 12 are ultrasonically welded to the bellows mounting base 11. In an alternative embodiment, the bellows 12 are glued to the bellows mounting base 11. The bellows assembly is installed in the cylinder 14, and the lock ring 13 is installed and tightened onto the cylinder.

In an alternative embodiment, and referring to FIGS. 9A-H, subsystem B may be assembled without bellows as follows. A ⅛″ NPT hole is drilled and tapped into the cylinder 14 for the zirk fitting 18, and the zirk fitting is screwed in. Two O-rings 15A are installed onto the piston 16, and the piston is inserted into the cylinder 14. One O-ring 15B is installed onto the cylinder 14. The bellows mounting base 11 is installed into the cylinder 14, and the lock ring 13 is installed and tightened onto the cylinder.

The prototype lubricator was loaded with grease as the fluid to be dispensed, and discharged at room temperature against atmospheric pressure, through a 5.8 kOhm resistor driven by the 3 Volt lithium batteries, with results shown in FIG. 9I.

In an embodiment of the invention, the integrated fluid transportation apparatus may be refilled by a user as follows. The switch cap 1 is removed from the power head, and the power head assembly 9 is unscrewed and removed. The fluid reservoir 17 is filled, for example where the fluid is a grease by using a grease gun attached to the zirk fitting 18, and a replacement power head assembly 9 is screwed in. The dip switches on the circuit board are set to the desired setting, and the switch-cap 1 is replaced onto the power head assembly 9.

### The Control Circuit

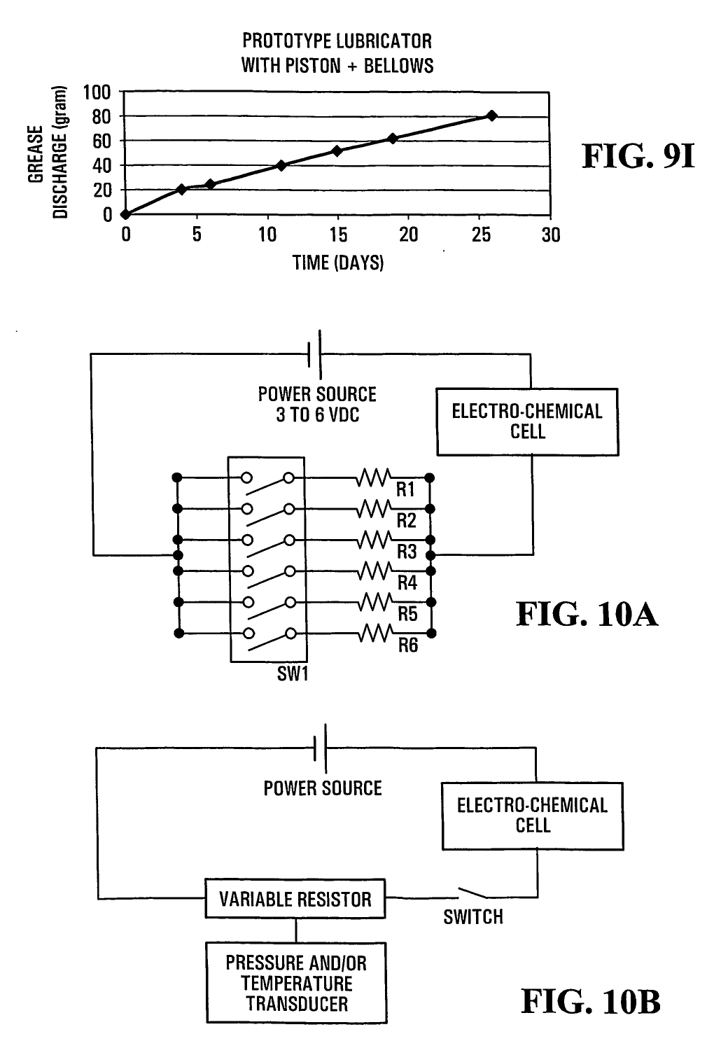

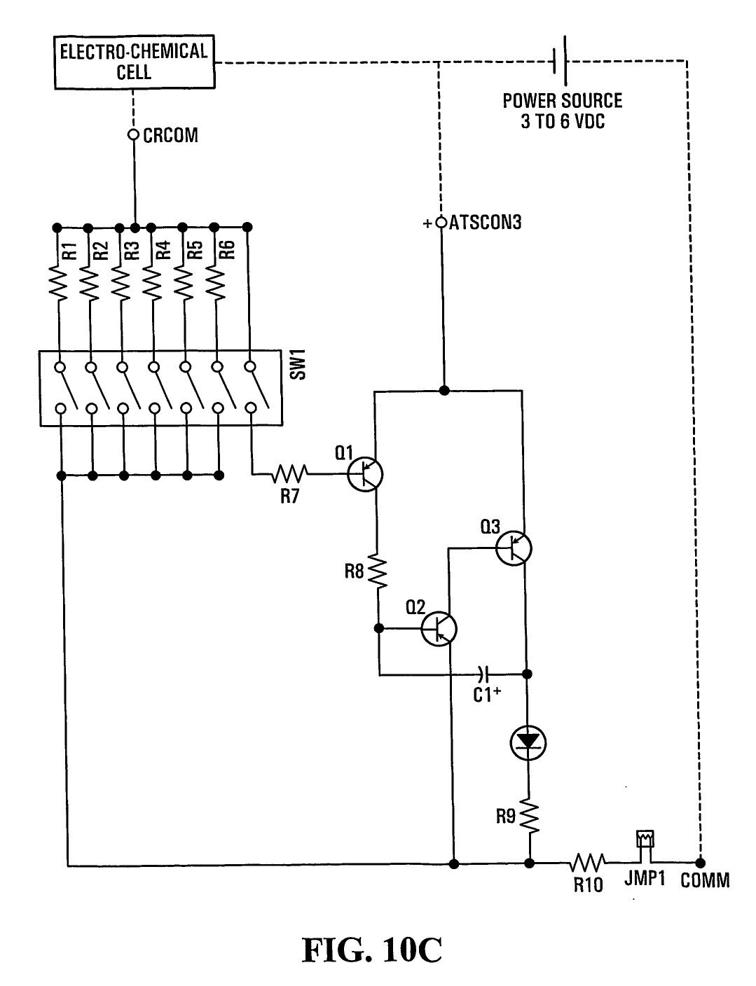

FIGS. 10A-C show embodiments of the electrical circuit used to control the current, and hence the gas generation rate, in the electrochemical cell. FIG. 10A is a conceptual diagram of a basic control circuit with multiple resistors and switches. FIG. 10B is a conceptual diagram of a more advanced control circuit in which the current is modulated by variation in the pressure and/or temperature in the lubricator. FIG. 10C shows the circuit of FIG. 10A with details of the type needed for its commercial production.

The control circuit of FIG. 10C includes a LED (light emitting diode) D1 which flashes at a fixed interval to indicate the proper operation of the electro-chemical cell and the valid status of the batteries. Resistor R9 limits the current flow through the LED and provides short circuit protection. FIG. 10C also include driving circuitry for the LED, (Q1, Q2, Q3, R7, R8, C1), which is fed by a feedback signal from the electro-chemical cell through switch (7) of SW1. This ensures that the LED operates only when current is flowing through the electro-chemical cell.

Switches 1-6 of SW1 and resistors R1-6 are used to control the current flow to the electro-chemical cell. When switch (1) is closed, then resistor R1 limits the current to the cell. When switch (2) is closed, then resistor R2 limits the current to the cell, and similarly with the remaining switches and corresponding resistors. Since the resistors are connected in parallel, when more than 1 switch is closed, the current limiting resistor value is R=1/S, where S is the sum of the inverse values of the resistors corresponding to the closed switches. Alternatively, and with the same effect, the current can be controlled by a single continuously variable resistor (sometimes called a “pot”). By varying the current flow through the electro-chemical cell, different rates of gas production are obtained. R10 is a current limiting resistor used to limit the maximum current flow through the circuit board when required for safety approvals.

While the invention has been described in connection with specific embodiments thereof, it will be understood that it is capable of further modifications and this application is intended to cover any variations, uses, or adaptations of the invention following, in general, the principles of the invention and including such departures from the present disclosure that come within known or customary practice within the art to which the invention pertains, and may be applied to the essential features set forth herein and in the scope of the appended claims.

All patents, patent applications, and publications referred to herein are hereby incorporated by reference in their entirety to the same extent as if each individual patent, patent application, or publication was specifically and individually indicated to be incorporated by reference in its entirety.

What is claimed is:

1. A reusable fluid dispenser comprising:
a) subsystem B having a fluid reservoir adapted for containing a fluid, the fluid reservoir comprising:
(i) a fluid outlet adapted for dispensing fluid contained in the fluid reservoir;
(ii) a separator movably positioned in a dispensing position to bias fluid contained in the fluid reservoir out of the fluid outlet, to dispense the fluid through the fluid outlet;
(iii) a fluid inlet positioned for recharging the fluid reservoir with the fluid while biasing the separator into the dispensing position, and
b) subsystem A having a power head assembly removably attached to the fluid reservoir comprising a gas generator in fluid communication with the separator, wherein gas generated by the gas generator is communicable to the separator to move the separator to dispense the fluid,
wherein a union seal couples subsystem A to subsystem B so as to limit escape of the gas generated by the gas generator in communication with the separator, to form a sealed union of subsystem A with subsystem B.

2. The apparatus of claim 1, wherein said fluid inlet comprises a one-way fluid fitting.

3. The apparatus of claim 1, wherein said separator is capable of preventing gas from moving into said reservoir.

4. The apparatus of claim 1, wherein said gas generating means is capable of generating gas by a gas generating reaction selected from the group consisting of a spontaneous electrochemical reaction, a non-spontaneous electrochemical reaction, and a spontaneous thermochemical reaction.

5. The apparatus of claim 4, wherein said gas generating reaction is spontaneous.

6. The apparatus of claim 4, wherein the rate of said gas generating reaction is adjustable.

7. The apparatus of claim 1, wherein said fluid is a lubricant.

8. The apparatus of claim 7, wherein said lubricant is a bearing grease.

9. The apparatus of claim 7 in which the lubricant is an oil.

10 The apparatus of claim 1, wherein said separator is selected from the group consisting of a bellows, a bladder, a piston, bellows and piston, and bladder and piston.

11. The apparatus of claim 1, wherein said separator comprises a bellows and piston.

12. The apparatus of claim 1, wherein said fluid is replaceable.

13. The apparatus of claim 1, wherein said power head assembly is replaceable.

14. The apparatus of claim 1, wherein said apparatus has replaceable components, selected from the group consisting of,
i ) a power head comprising:
a. a switchboard, a battery, a non-spontaneous electrochemical cell and a switchcap or
b. a switchboard, a spontaneous electrochemical cell and a switchcap, or
c. a reactive (thermo-chemical) solid element, a reactive liquid and means to bring the solid element and the reactive fluid into contact;
ii) a cylinder or a lubricant reservoir,
iii) a bellows comprising a mounting base;
iv) a bladder comprising a mounting base;
v) a piston;
vi) a locking ring;
vii) the fluid; and,
viii) a union seal for coupling Subsystem A to Subsystem B so as to prevent the escape of gas from the union.
